(19) United States
(12) Patent Application Publication
(10) Pub. No.: US 2012/0024083 A1
(43) Pub. Date: Feb. 2, 2012

(54) DISK-BASED FLUID SAMPLE SEPARATION DEVICE

(75) Inventors: ANDREW MAN CHUNG WO, TAIPEI CITY (TW); CHEN-LIN CHEN, TAIPEI CITY (TW); CHENG WEI YANG, TAIPEI CITY (TW)

(73) Assignee: NATIONAL TAIWAN UNIVERSITY, TAIPEI CITY (TW)

(21) Appl. No.: 13/104,289

(22) Filed: May 10, 2011

(30) Foreign Application Priority Data
Aug. 2, 2010 (TW) 99125646

(51) Int. Cl. G01N 1/10

(52) U.S. Cl. 73/863.21

(57) ABSTRACT

A disk-based fluid sample separation device including at least one air vent forming a part of a flow channel pattern on a microfluidic disk is disclosed. The fluid sample separation device is provided with an air vent sealing cover having at least through hole and is placed on the top surface of the disk. The air vent sealing cover is rotated with respect to the disk either at a first position or a second position. At the first position, the hole of the air vent sealing cover is in correspondence to the air vent of the flow channel pattern to control the sample liquid delivery. At the second position, the air vent of the flow channel pattern is closed. The flow channel pattern includes at least one sample storage reservoir, at least one sample processing reservoir, and at least one communication channel which is in fluid communication between the sample storage reservoir and the sample processing reservoir. In alternative, the status of the hole of the air vent sealing cover is controlled by a control unit.

### FIELD OF THE INVENTION

The present invention relates to a fluid sample separation device, and in particular to a disk-based fluid sample separation device that selectively allows a fluid sample contained in a sample storage reservoir to flow to a sample processing reservoir through the control of air vent and being subjected to a rotating motion.

### BACKGROUND OF THE INVENTION

Techniques for fluid sample separation are of wide applications, such as separation of cells, separation of fetal cells, cell separation for whole blood samples, and separation of endothelial colony forming cells (ECFC) contained in umbilical cord blood (UCB).

For example, detection and quantification of cancer cells or rare cells present in body fluids are regarded as a potential indicator for clinical diagnoses, prognostication, and biomedicine research. For example, circulating tumor cells (CTC) are rare in the blood of patients with metastatic cancer, and it is possible to monitor the response of CTC to adjuvant therapy. Such rear cells must be first separated from the body fluids, before detection and quantification of these rare cells can be made. For such a purpose, various cell techniques have been developed.

The cell separation techniques that are commonly used includes fluorescence activated cell separation (FACS), dielectrophoresis (DEP) cell separation, separation techniques that employ massively parallel microfabricated sieving devices, magnetically activated cell separation (MACS), and other techniques that uses optics and acoustics. Among these cell separation techniques, FACS and MACS are most often used.

Although it is often used, FACS is disadvantageous in respect of high cost, difficulty in disinfection, and consuming a great amount of sample in the operation thereof. Contrary to FACS, MACS is efficient to obtain a major quantity of target cells in a short period with a reduced consumption of sample. However, these cells must be transferred to a slide or an observation platform before they can be observed with a microscope. Such a process of transfer often leads to a great loss of cells.

Since MACS shows advantages in respect of high throughput, high performance, and simplified facility, it is often adopted in separation of fluid samples. Using immune cells to separate a desired component from a blood sample and the operation of immunofluorescence require multiple samples and manually-operated transfer, so that the result of detection is heavily dependent upon the skill of an operator, making it not fit for industrial use.

### SUMMARY OF THE INVENTION

In view of the above description of the conventional techniques, it is a major issue for this field to provide a fluid sample separation technique that realizes high throughput of cell selection, easy operation, low cost, simple facility, and excellent sensitivity and reliability.

Thus, an objective of the present invention is to provide a disk based fluid sample separation device, which is of low cost, is easy for detection and observation, and has reduced cell loss, and is applicable to separate a labeled component from a fluid sample.

Another objective of the present invention is to provide a disk based fluid sample separation device that is operated to selectively conduct a fluid sample contained in a sample storage reservoir to a sample processing reservoir by means of control realized by an air vent and rotary motion.

A further objective of the present invention is to provide a disk based fluid sample separation device that is operated to separate, in a fluid sample, at least two types of cells, which are respectively labeled and not labeled with the immunomagnetic beads.

The solution adopted in the present invention to achieve the above objectives is a microfluidic disk that forms therein a flow channel pattern. The flow channel pattern comprises at least one air vent. A sealing cover is set on a top surface of the microfluidic disk. The sealing cover forms at least one air passage. The sealing cover is rotatable with respect to the microfluidic disk between a first position, where the air passage of the sealing cover communicates the air vent of the flow channel pattern, and a second position, where the sealing cover closes the air vent of the flow channel pattern. The flow channel pattern comprises a sample storage reservoir, at least one sample processing reservoir, and a communication channel communicating between the sample storage reservoir and the sample processing reservoir. The sealing cover is operable through manual rotation or electrically-driven rotation to have the air passage of the sealing cover to align or close the air vent of a selected sample storage reservoir. In an embodiment of the present invention, the air vent of the sealing cover is replaced by a solenoid-controlled air vent structure.

In a preferred embodiment of the present invention, at least one magnetic unit is set on a top of the sealing cover at a location corresponding to the sample processing reservoir of the microfluidic disk for providing a uniform magnetic force of predetermined magnitude on the sample processing reservoir.

When the present invention is applied to separation of magnetically-labeled components contained in a fluid sample, it is capable of capturing all the magnetically-labeled components in whole blood cells. Further, the disk-based fluid sample separation device according to the present invention can be manufactured with a simple process, which can be carried out with laser machining, CNC machining, micromachining, or injection molding. Further, the material for manufacturing the disk is readily available, leading to an advantage of low manufacturing cost.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view showing a disk-based fluid sample separation device constructed in accordance with a first embodiment of the present invention;

FIG. 2 is an exploded view showing the disk-based fluid sample separation device of first embodiment of the present invention;

FIG. 3 is a top plan view showing a microfluidic disk of the first embodiment of the present invention;

FIG. 4 is a top plan view showing a sealing cover of the first embodiment of the present invention;

FIG. 5 is a schematic view showing an air passage of the sealing cover of the present invention in alignment with an air vent of a sample storage reservoir to set the air vent in an open condition;

FIG. 6 is a cross-sectional view showing the sealing cover of FIG. 5 in a first position;

FIG. 7 is a schematic view showing the sealing cover of the present invention being rotated by an angle to have the air passage aligning an air vent of another sample storage reservoir to set the air vent in an open condition;

FIG. 8 is a cross-sectional view showing the sealing cover of FIG. 7 in a second position;

FIG. 9 is a schematic view showing the air vent of the sample storage reservoir of the present invention in a closed condition, whereby a fluid sample contained in the sample storage reservoir is not allowed to flow to a sample processing reservoir;

FIG. 10 is a schematic view showing the air vent of the sample storage reservoir of the present invention in an open condition, whereby a fluid sample contained in the sample storage reservoir is acted upon by a centrifugal force to flow through a communication channel to the sample processing reservoir;

FIG. 11 is a cross-sectional view taken along line 11-11 of FIG. 1;

FIG. 12-16 are schematic views demonstrating a fluid sample contained in the sample storage reservoir according to the present invention and secondary samples contained in secondary sample storage reservoirs conducted, under the control of air vents and subjected to rotating motion, to the sample processing reservoir;

FIG. 17 is an exploded view showing a disk-based fluid sample separation device constructed in accordance with a second embodiment of the present invention;

FIG. 18 is a top plan view showing a disk-based fluid sample separation device constructed in accordance with a third embodiment of the present invention;

FIG. 19 is a cross-sectional view taken along line 19-19 of FIG. 18;

FIG. 20 is a cross-sectional view of an air passage opening/closing control unit of FIG. 19 setting an air vent in an open condition;

FIG. 21 is a cross-sectional view of the air passage opening/closing control unit of FIG. 19 setting an air vent in a closed condition;

FIG. 22 is a top plan view showing a disk-based fluid sample separation device constructed in accordance with a fourth embodiment of the present invention; and

FIG. 23 is a cross-sectional view taken along line 23-23 of FIG. 22.

### DETAILED DESCRIPTION OF THE PREFERRED EMBODIMENTS

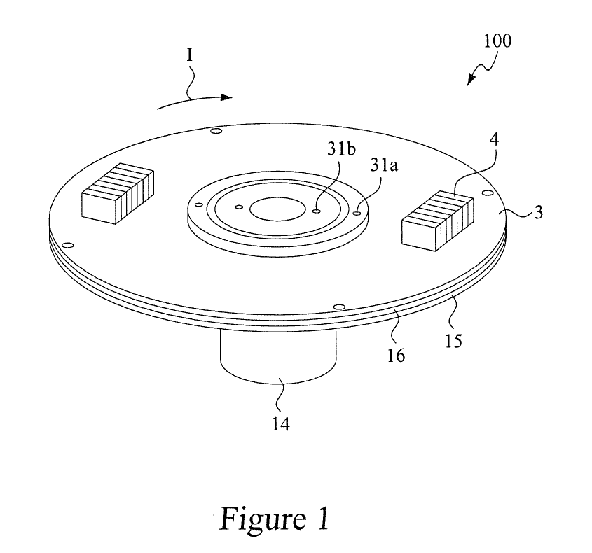

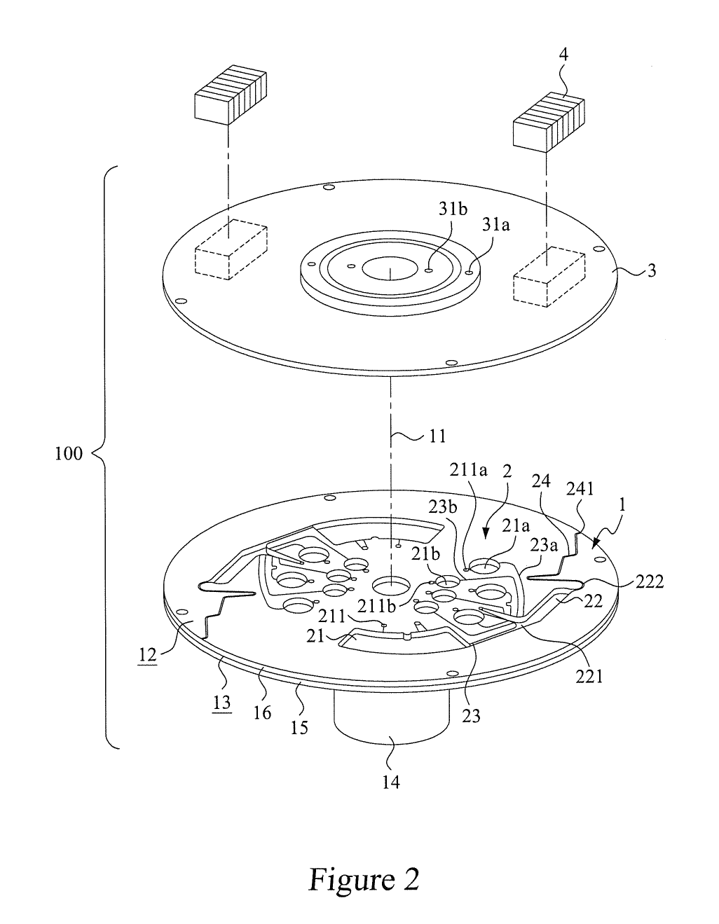

With reference to the drawings and in particular to FIG. 1, which is a perspective view showing a disk-based fluid sample separation device constructed in accordance with a first embodiment of the present invention, and FIG. 2, which is an exploded view showing the disk-based fluid sample separation device of first embodiment of the present invention, the disk-based fluid sample separation device according to the present invention, generally designated at 100, comprises a microfluidic disk 1, which has a geometric center 11, a top surface 12, and a circumferential surface 13, and is coupled, at the geometric center 11, to a spindle of a rotation driving device 14, whereby the microfluidic disk 1 is selectively driven by the rotation driving device 14 to rotate about the geometric center 11, which serves as a rotation center, in a predetermined rotation direction I.

The microfluidic disk 1 forms a flow channel pattern 2. In the instant embodiment, the microfluidic disk 1 is composed of a bottom base board 15 and a flow channel pattern layer 16 formed on the bottom base board 15. The flow channel pattern 2 is defined in and by the flow channel pattern layer 16. The microfluidic disk 1 is covered by a sealing cover 3 set on the top surface 12 thereof.

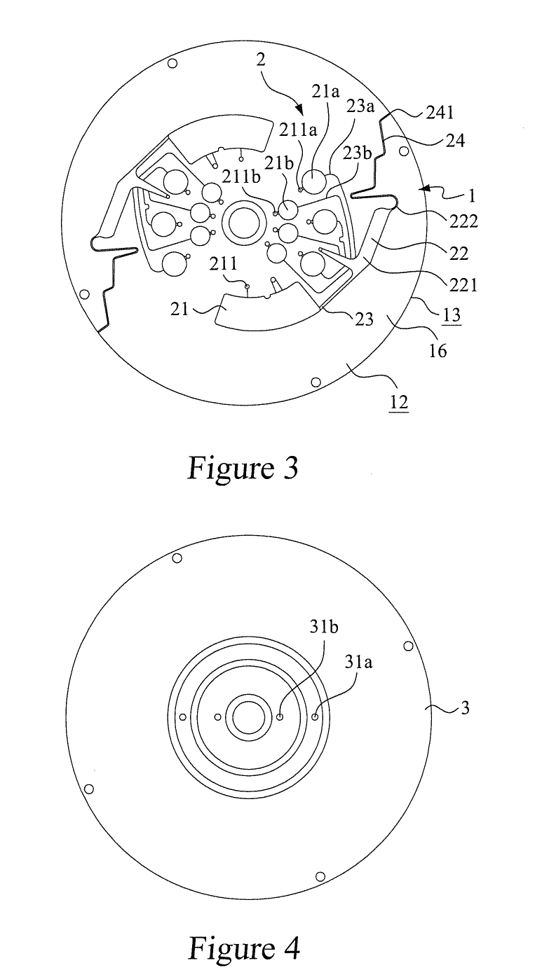

Referring also to FIG. 3, which is a top plan view of the microfluidic disk 1 shown in FIG. 2, the flow channel pattern 2 comprises at least one sample storage reservoir 21, which is formed in the flow channel pattern layer 16 of the microfluidic disk 1 to store a fluid sample (such as a blood sample). The sample storage reservoir 21 is in fluid communication with at least one air vent 211. The flow channel pattern 2 also comprises at least one secondary sample storage reservoir 21a, which is formed in the flow channel pattern layer 16 of the microfluidic disk 1 for store a secondary sample (such as reaction reagent). Each of the secondary sample storage reservoirs 21a is set in fluid communication with a respective air vent 211a.

A plurality of secondary sample storage reservoirs 21a that comprises air vents 211a may be arranged on the microfluidic disk 1 as a circle centered at the geometric center 11. Alternatively, secondary sample storage reservoirs comprising air vents may be arranged along inner and outer concentric circles on the microfluidic disk 1. In the embodiment illustrated, a plurality of secondary sample storage reservoirs 21a that each comprises an air vent 211a is arranged as an outer circle in the flow channel pattern layer 16 of the microfluidic disk 1, and a plurality of secondary sample storage reservoirs 21b that each comprises an air vent 211b is arranged as an inner, concentric circle in the flow channel pattern layer 16 of the microfluidic disk 1.

The flow channel pattern 2 further comprises at least one sample processing reservoir 22. The sample processing reservoir 22 is located closer to the circumferential surface 13 of the microfluidic disk 1 than the sample storage reservoir 21 is. The sample processing reservoir 22 has a fluid inlet end 221 and a fluid outlet end 222. The fluid inlet end 221 communicates through at least one communication channel 23, 23a with the sample storage reservoir 21 and the secondary sample storage reservoirs 21a. The fluid outlet end 222 communicates with a capillary 24. The capillary 24 has an opposite end extending to the circumferential surface 13 of the microfluidic disk 1 to form an opening 241.

In the instant embodiment, the bottom base board 15 and the flow channel pattern layer 16 are both made of acrylic resins, such as polymethylmethacrylate (PMMA), and the sealing cover 3 is made of a transparent material. Laser light, such as CO2 laser, is employed to machine the flow channel pattern layer 16 for forming the flow channel pattern 2. The flow channel pattern layer 16 so formed may then be combined with the bottom base board 15. Afterwards, the sealing cover 3 is set to cover the flow channel pattern layer 16 to thereby seal the top of the flow channel pattern 2.

Apparently, the flow channel pattern layer 16 can alternatively be formed as a multiple-layered structure by stacking or laminating multiple layers. Further, the microfluidic disk 1 can be alternatively made a single-layered structure and the material used is not limited to acrylic resins. The flow channel pattern 2 can alternatively be machined by for example other types of laser machining, or CNC machining, micromachining, and injection molding.

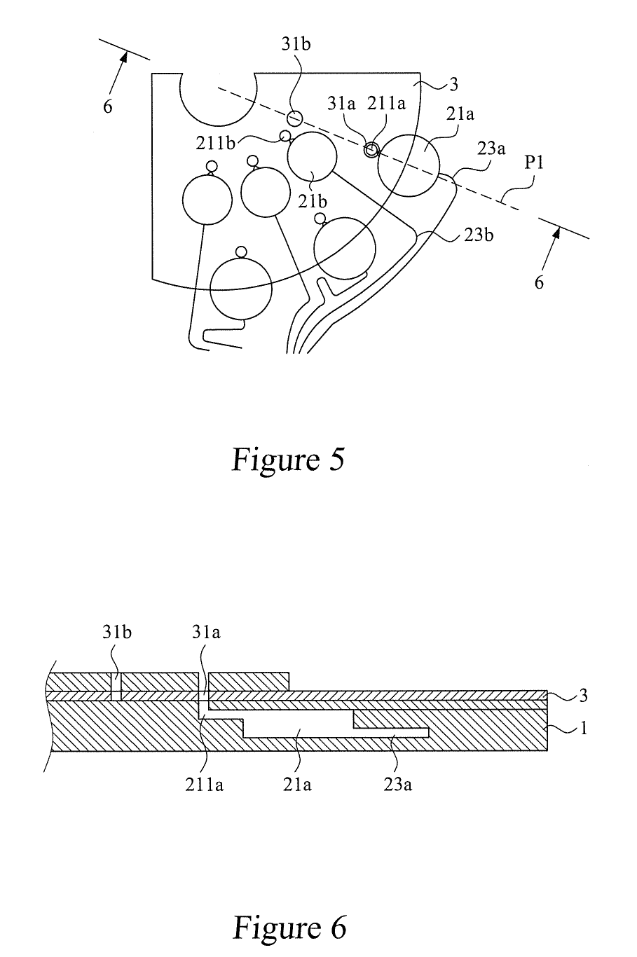

The sealing cover 3 is positioned on the top surface of the microfluidic disk 1 and forms at least one air passage 31a, 31b (also see FIGS. 2 and 4). The sealing cover 3 is rotatable with respect to the microfluidic disk 1. For example, when the sealing cover 3 is rotated to a first angular position P1 (also see FIG. 5, as well as the cross-sectional view of FIG. 6), the air passage 31a of the sealing cover 3 is located exactly corresponding to the air vent 211a of the sample storage reservoir 21a, thereby setting the air vent 211a in an open condition, while the air vents of the remaining sample storage reservoir are kept in a closed condition. Under this condition, the microfluidic disk 1 is driven to rotate about the geometric center 11, and the air passage (such as 31a) of the sealing cover 3 is in alignment with the air vent (such as 211a) of a selected sample storage reservoir (such as 21a), the fluid sample stored in the selected sample storage reservoir 21a may be driven by a centrifugal force to flow through the communication channel 23a into the sample processing reservoir 22.

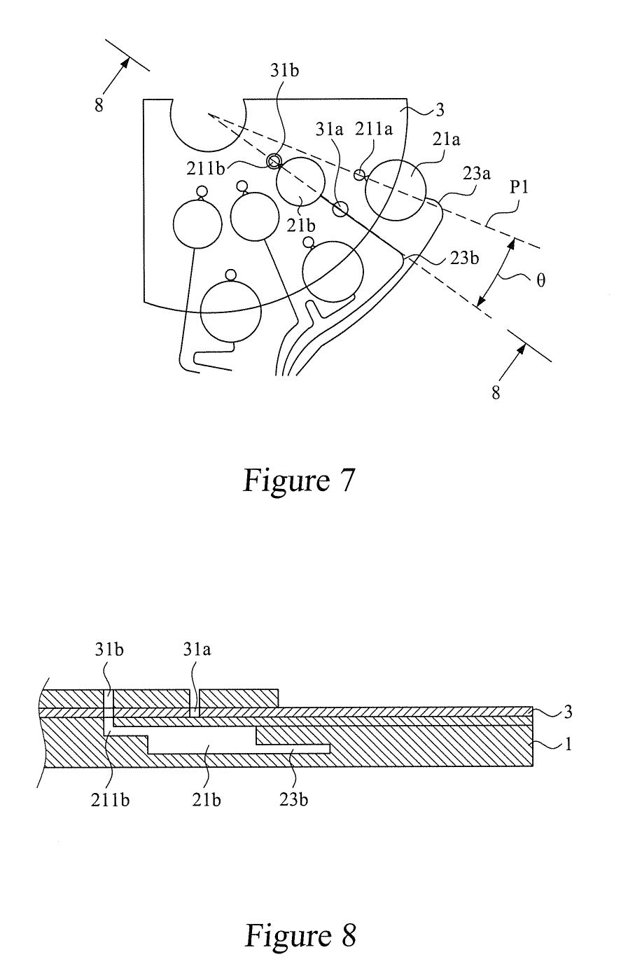

When the sealing cover 3 is rotated by a predetermined angle θ (also see FIG. 7, as well as the cross-sectional view of FIG. 8), the air passage 31b of the sealing cover 3 is positioned to align the air vent 211b of the sample storage reservoir 21b, thereby setting the air vent 211b in an open condition, while the air vents of the remaining sample storage reservoirs are kept closed. The number of the air passages formed in the sealing cover 3 may be varied as desired, and the locations where the air passages are formed are also variable as desired. Through the selective rotation of the sealing cover 3, it is possible to selectively set the air vent of each individual sample storage reservoir in an open condition or a closed condition.

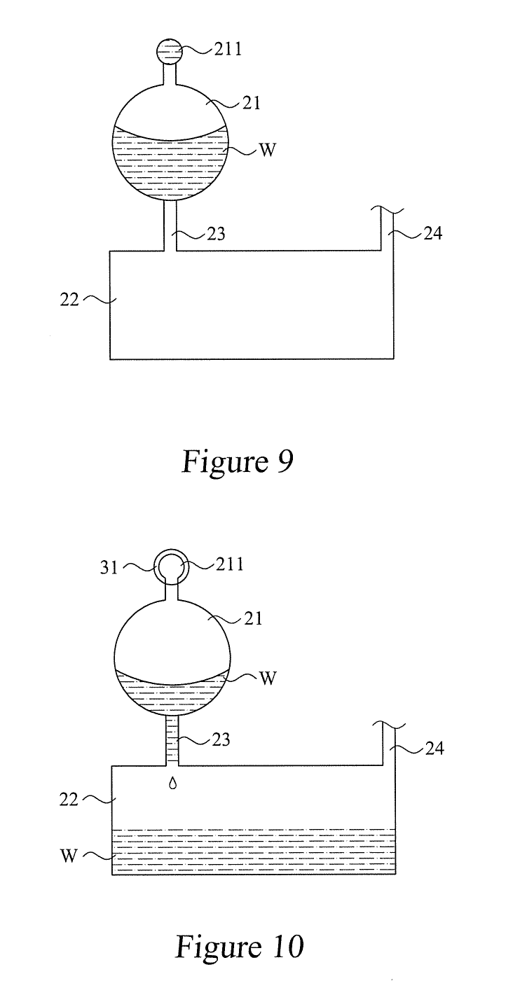

Taking the sample storage reservoir 21 as an example, when the air vent 211 of the sample storage reservoir 21 is set in a closed condition (see FIG. 9), the fluid sample W contained in the sample storage reservoir 21 is not allowed to flow to the sample processing reservoir 22, whether the microfluidic disk 1 is kept standstill (not in rotation) or the microfluidic disk 1 is in rotation. On the other hand, when the air vent 211 of the sample storage reservoir 21 in an open condition (see FIG. 10), if the microfluidic disk 1 is kept in standstill (not in rotation), the fluid sample W contained the sample storage reservoir 21 cannot flow to the sample processing reservoir 22, but if the microfluidic disk 1 is driven and rotated, the fluid sample W contained in the sample storage reservoir 21 is acted upon by centrifugal force to flow into the sample processing reservoir 22.

With such an operation model, for an arrangement of a plurality of sample storage reservoirs, the angular displacement θ of the sealing cover 3 can be selected through rotation of the cover (see FIG. 7) in order to selectively set the air vents of some of the sample storage reservoirs in a closed condition, while the air vents of the selected sample storage reservoirs are simultaneously opened to allow the fluid samples contained in the selected sample storage reservoirs to flow into the sample processing reservoir. Repeating the rotating and positioning process for the sealing cover 3 would allow the fluid sample contained in each of the sample storage reservoirs to be conducted into the sample processing reservoir (see FIG. 10).

Compared to a hydrophobic valve or a capillary valve adopted in the conventional centrifugal microfluidic platforms, the device of the present invention is less prone to influence by the nature of fluid sample, surface characteristics, size of communication channel, and rotational speed of microfluidic disk.

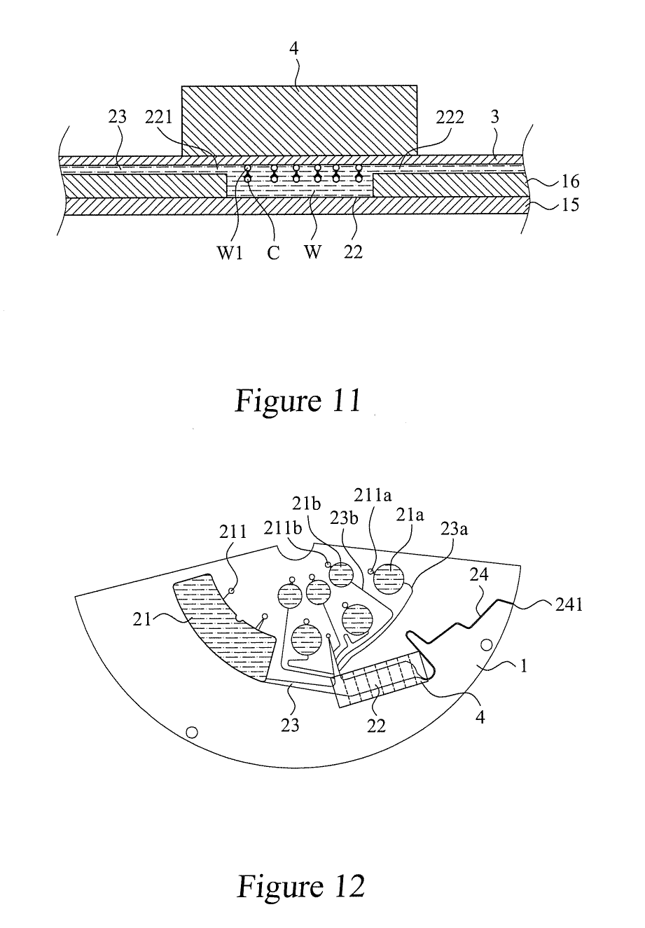

Also referring to FIG. 11, which is a cross-sectional view taken along line 11-11 of FIG. 1, at least one magnetic unit 4 is additionally provided on the top of the sealing cover 3 at a location corresponding to the sample processing reservoir 22 of the microfluidic disk 1 for providing a predetermined magnetic field above the sample processing reservoir 22 of the microfluidic disk 1.

In an example application, the present invention is applied to separation of cells that are labeled with immunomagnetic beads. A fluid sample W with which the operation of cell separation is to be performed is first filled into the sample storage reservoir 21. The fluid sample W contains two types of cell, one of which (target samples W1) is labeled with immunomagnetic beads C. With the sealing cover 3 being angularly displaced to have the air passage 31a aligning the air vent 211 of the sample storage reservoir 21 and thus opening the air vent 211, when the microfluidic disk 1 is driven by the rotation driving device 14 to rotate in a predetermined rotation direction I, the fluid sample W is acted upon by the centrifugal force induced by the rotation of the microfluidic disk 1 and thus flows from the sample storage reservoir 21 through the communication channel 23 into the sample processing reservoir 22. Under this condition, the target samples W1 that are labeled with immunomagnetic beads C contained in the fluid sample W are subjected to magnetic attraction induced by the magnetic unit 4 to collect at the underside of the sealing cover 3. In the embodiment illustrated, the magnetic unit 3 comprises a rectangular array of magnets, which applies a uniform magnetic field of a predetermined intensity on the sample processing reservoir 22 of the microfluidic disk 1.

In another example of application, the present invention is used to separate for example MCF7 cells and Jurkat cells. It is apparent that the present invention is applicable to separation of fetal cells, separation of cells from whole blood sample, and separation of endothelial colony forming cells (ECFC) contained in umbilical cord blood (UCB).

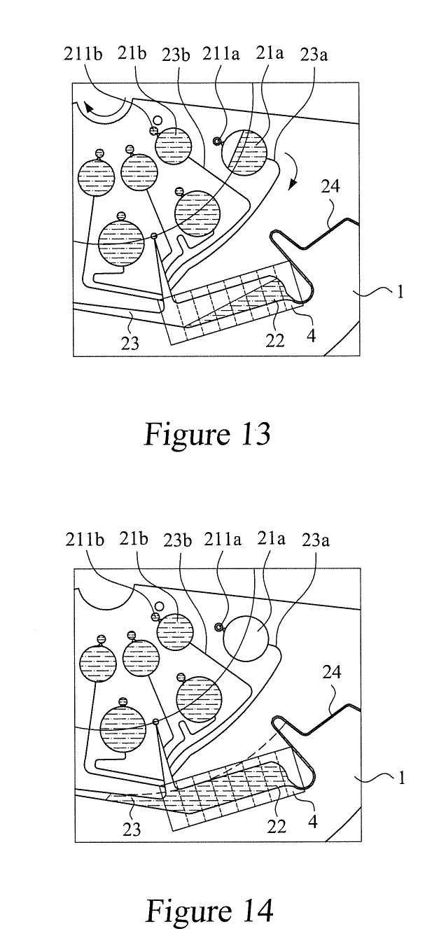

FIGS. 12-16 are schematic views demonstrating a fluid sample contained in the sample storage reservoir according to the present invention and secondary samples contained in secondary sample storage reservoirs conducted, under the control of air vents and subjected to rotating motion, to the sample processing reservoir. Firstly, the fluid sample is filled into the sample storage reservoir 21 and secondary samples are respectively filled into the respective secondary sample storage reservoirs 21a, 21b (see FIG. 12). The sealing cover 3 is then rotated to have the air passage 31b of the sealing cover 3 aligning the air vent 211a of the sample storage reservoir 21a. Afterwards, when the microfluidic disk 1 is put into rotation, the secondary sample contained in the secondary sample storage reservoir 21a is acted upon by a centrifugal force to flow through the communication channel 23a into the sample processing reservoir 22 (see FIG. 13).

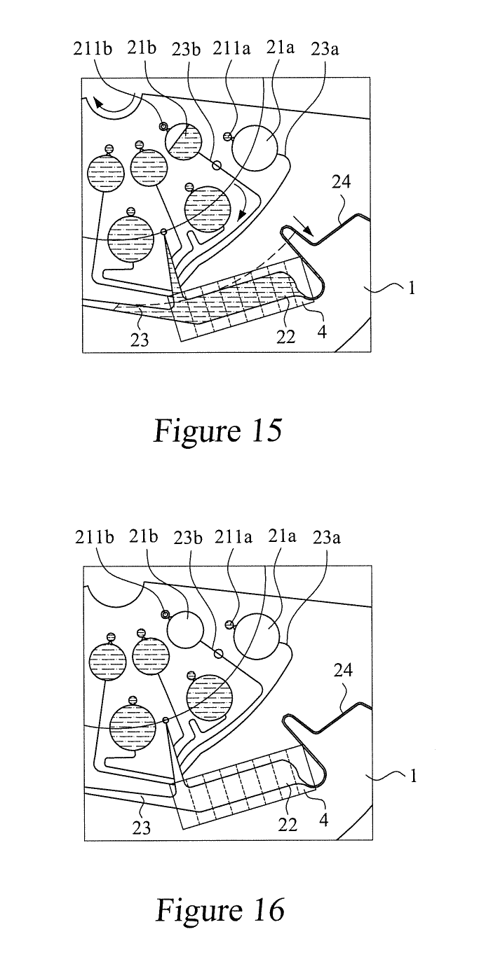

After the secondary sample of the secondary sample storage reservoir 21a is completely received into the sample processing reservoir 22 (see FIG. 14), the sealing cover 3 may be rotated again to have the air passage 31a of the sealing cover 3 aligning the air vent 211b of the sample storage reservoir 21b (see FIG. 15). Under this condition, when the microfluidic disk 1 is put into rotation, the secondary sample contained in the secondary sample storage reservoir 21b is acted upon by a centrifugal force to flow through the communication channel 23b into the sample processing reservoir 22 (see FIG. 16). As such, through sequential rotation of the sealing cover 3, the fluid sample contained in the sample storage reservoir 22 and the secondary samples contained in the secondary sample storage reservoirs 21a, 21b can be individually conducted into the sample processing reservoir 22.

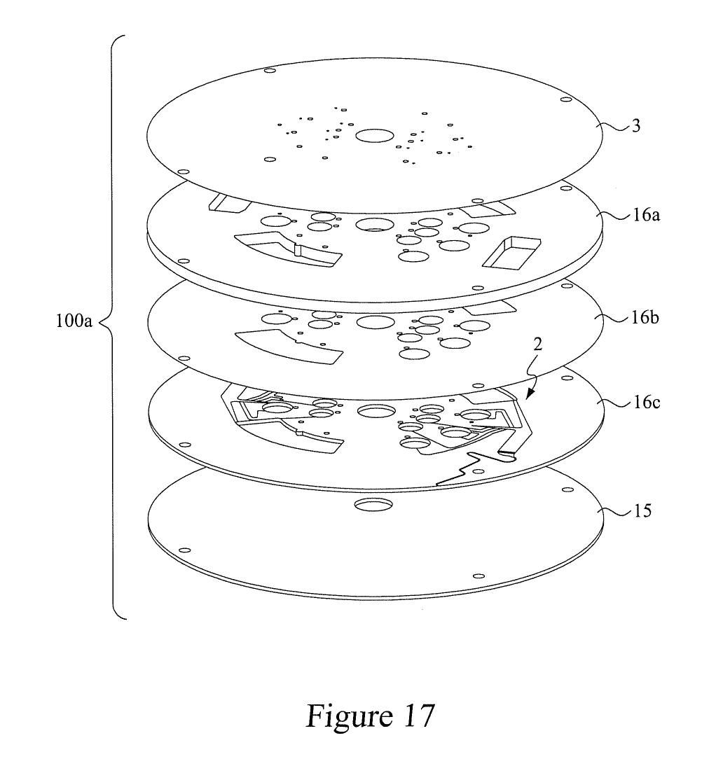

FIG. 17 is an exploded view showing a disk-based fluid sample separation device constructed in accordance with a second embodiment of the present invention, wherein the disk-based fluid sample separation device 100a of the second embodiment is formed of multiple layers stacked together, comprising a sealing cover 3, three flow channel pattern layers 16a, 16b, 16c, and a bottom base board 15.

In the previously discussed embodiments, the sealing cover 3 is positioned on the microfluidic disk 1 and is manually operable for rotation so as to have the air passage of the sealing cover 3 to correspond to or close an air vent of a selected sample storage reservoir. In another embodiment of the present invention, manual rotation of the sealing cover 3 is substituted by motor-driven rotation. Further, the air vent of the sealing cover 3 may be replaced by a solenoid controlled air vent structure.

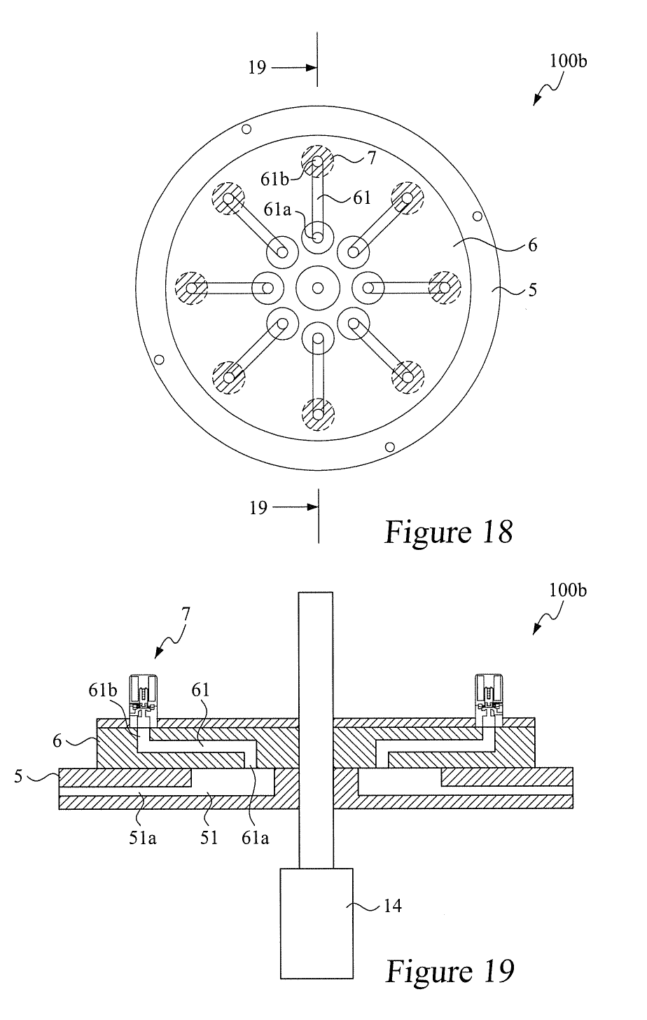

For example, FIG. 18 is a top plan view showing a disk-based fluid sample separation device constructed in accordance with a third embodiment of the present invention, and FIG. 19 is a cross-sectional view taken along line 19-19 of FIG. 18. In this embodiment, the disk-based fluid sample separation device, which is designated at 100b, similarly comprises a microfluidic disk 5 that forms a flow channel pattern composed of a plurality of sample storage reservoirs 51 and/or secondary sample storage reservoir(s). A sealing cover 6 is set to cover the microfluidic disk 5. The sealing cover 6 forms air vent channels 61 corresponding to the sample storage reservoirs 51 of the microfluidic disk 5. Each air vent channel 61 has a top end to which an air passage opening/closing control unit 7 (such as a solenoid) is mounted and each air vent channel 61 has a bottom end 61a corresponding to and in fluid communication with the respective sample storage reservoir 51. The top end of each the air vent channel 61 forms an air passage 61b.

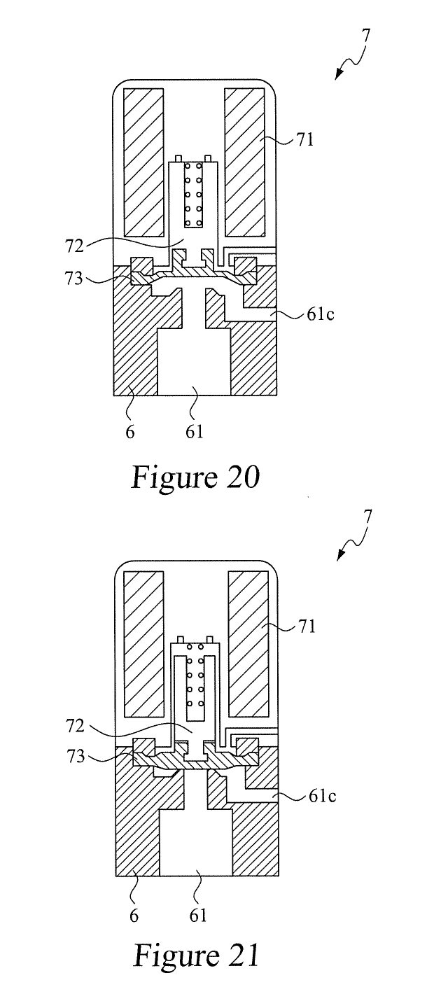

Referring to FIGS. 20 and 21, which are cross-sectional views of the air passage opening/closing control unit 7 respectively showing the air vent in open and closed conditions as being controlled by the air passage opening/closing control unit, the air passage opening/closing control unit 7 comprises a solenoid 71, an electromagnetic operation unit 72, and a valve membrane 73. When the solenoid 71 is excited by electrical power applied thereto, the electromagnetic operation unit 72 is operated to move the valve membrane 73 upwards, making the air vent channel 61 communicating an external air channel 61c (see FIG. 20), whereby the fluid sample contained in the sample storage reservoir 51, when acted upon by a centrifugal force, is allowed to flow out through the communication channel 51a. When the solenoid 71 does not receive electrical power applied thereto, the electromagnetic operation unit 72 is not operated and the valve disk 73 returns to the original position to block the air vent channel 61 from the external air channel 61c (see FIG. 21). Under this condition, the fluid sample stored in the sample storage reservoir 51 is prohibited from flowing out.

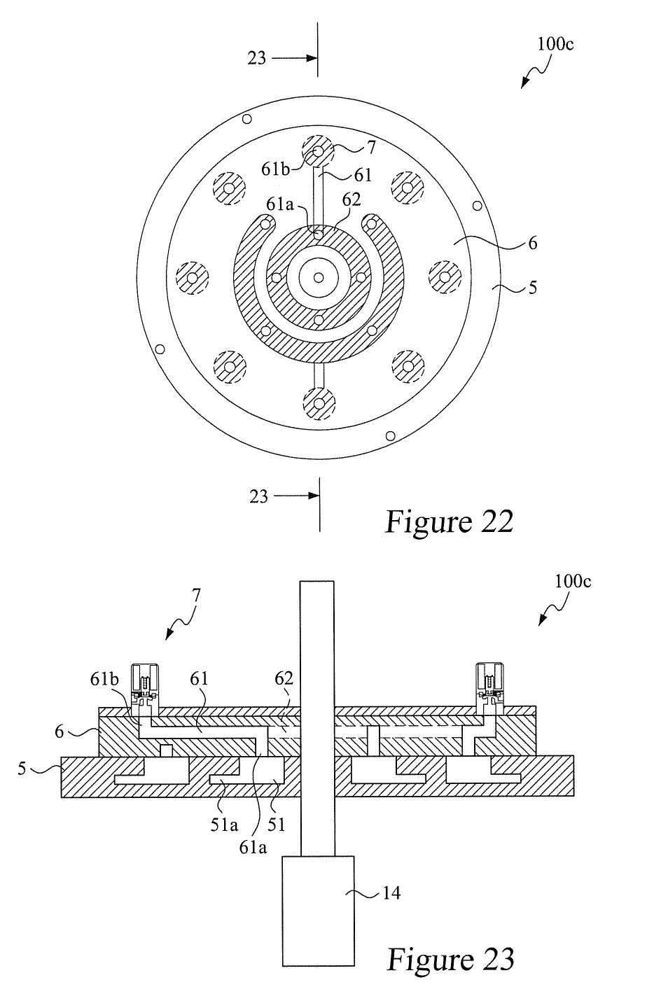

FIG. 22 is a top plan view showing a disk-based fluid sample separation device 100c constructed in accordance with a fourth embodiment of the present invention, and FIG. 23 is a cross-sectional view taken along line 23-23 of FIG. 22. In this embodiment, an arrangement that a single air passage opening/closing control unit 7 is operable for controlling multiple sample storage reservoirs 51 is provided. In other words, the sealing cover 6 has an air vent channel 61 that has a bottom end 61a, which besides being in fluid communication with a sample storage reservoir 51, is in communication with an extended air vent channel 2 for further communicating other sample storage reservoirs 51 through the extended air vent channel 62, whereby when the solenoid 71 of the air passage opening/closing control unit 7 is excited by electrical power applied thereto, the fluid samples contained in the sample storage reservoirs 51 that are in communication with both the air vent channel 61 and the extended air vent channel 62 are allowed to flow out through the communication channel 51a. When the solenoid 71 is not excited, the fluid sample contained in each of these sample storage reservoirs 51 is prohibited from flowing out.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A disk-based fluid sample separation device, comprising:
a microfluidic disk, which has a geometric center, a top surface, and a circumferential surface;
a flow channel pattern, which is formed in the microfluidic disk, the flow channel pattern comprising at least one air vent; and
at least one sealing cover, which is set on a top surface of the microfluidic disk and forms at least one air passage, the sealing cover being rotatable with respect to the microfluidic disk between a first position, where the air passage of the sealing cover communicates the air vent of the flow channel pattern, and a second position, where the sealing cover closes the air vent of the flow channel pattern.

2. The disk-based fluid sample separation device as claimed in claim 1, wherein the flow channel pattern comprises:
at least one sample storage reservoir, which is formed in the microfluidic disk for storing a fluid sample, the sample storage reservoir being in communication with the air vent;
at least one sample processing reservoir, which is formed in the microfluidic disk; and
at least one communication channel, which communicates between the sample storage reservoir and the sample processing reservoir;
whereby when the microfluidic disk is set in rotation about a rotation center defined by the geometric center, and the air passage of the sealing cover is set in the first position, the fluid sample stored in the sample storage reservoir is acted upon by a centrifugal force to flow through the communication channel to the sample processing reservoir.

3. The disk-based fluid sample separation device as claimed in claim 2, wherein the flow channel pattern comprises at least one secondary sample storage reservoir, which is formed in the microfluidic disk for storing a secondary sample, the secondary sample storage reservoir being in communication with at least one air vent and being connected by a communication channel to the sample processing reservoir.

4. The disk-based fluid sample separation device as claimed in claim 2, wherein the sample processing reservoir is connected through a capillary to an opening formed in the circumferential surface of the microfluidic disk.

5. The disk-based fluid sample separation device as claimed in claim 2, wherein the microfluidic disk comprises a bottom base board and at least one flow channel pattern layer, the sample storage reservoir, the sample processing reservoir, and the communication channel being formed in the flow channel pattern layer.

6. The disk-based fluid sample separation device as claimed in claim 2, wherein at least one magnetic unit is set on a top of the sealing cover at a location corresponding to the sample processing reservoir of the microfluidic disk.

7. A disk-based fluid sample separation device, comprising:
a microfluidic disk, which has a geometric center, a top surface, and a circumferential surface;
a flow channel pattern, which is formed in the microfluidic disk, the flow channel pattern comprising at least one air vent;
at least one sealing cover, which is set on a top surface of the microfluidic disk and forms at least one air passage and an air vent channel, the air vent communicating the at least one air vent of the flow channel pattern; and
an air passage opening/closing control unit, which is mounted between the air vent channel of the sealing cover and an external air channel to selectively open and close communication between the air vent channel and the external air channel.

8. The disk-based fluid sample separation device as claimed in claim 7, wherein the air passage opening/closing control unit comprises a solenoid.

9. The disk-based fluid sample separation device as claimed in claim 7, wherein the flow channel pattern comprises:
at least one sample storage reservoir, which is formed in the microfluidic disk for storing a fluid sample, the sample storage reservoir being in communication with the air vent;
at least one sample processing reservoir, which is formed in the microfluidic disk; and
at least one communication channel, which communicates between the sample storage reservoir and the sample processing reservoir;
whereby when the microfluidic disk is set in rotation about a center defined by the geometric center, and communication is open between the air vent channel and the external air channel, the fluid sample stored in the sample storage reservoir is acted upon by a centrifugal force to flow through the communication channel to the sample processing reservoir.

10. The disk-based fluid sample separation device as claimed in claim 9, wherein the flow channel pattern comprises at least one secondary sample storage reservoir, which is formed in the microfluidic disk for storing a secondary sample, the secondary sample storage reservoir being in communication with at least one air vent and being connected by a communication channel to the sample processing reservoir.

11. The disk-based fluid sample separation device as claimed in claim 9, wherein the sample processing reservoir is connected through a capillary to an opening formed in the circumferential surface of the microfluidic disk.

12. The disk-based fluid sample separation device as claimed in claim 9, wherein the microfluidic disk comprises a bottom base board and at least one flow channel pattern layer, the sample storage reservoir, the sample processing reservoir, and the communication channel being formed in the flow channel pattern layer.

13. The disk-based fluid sample separation device as claimed in claim 9, wherein at least one magnetic unit is set on a top of the sealing cover at a location corresponding to the sample processing reservoir of the microfluidic disk.
